(19) United States
(12) Patent Application Publication
(10) Pub. No.: US 2014/0344115 A1
(43) Pub. Date: Nov. 20, 2014

(54) PRODUCT SEARCH SYSTEM

(71) Applicants: Tomoko Yatsuda, Kyoto (JP); Takeshi Nagai, Kyoto (JP); Takeshi Kasamaki, Kyoto (JP); Katsuhiro Suzuki, Kyoto (JP)

(72) Inventors: Tomoko Yatsuda, Kyoto (JP); Takeshi Nagai, Kyoto (JP); Takeshi Kasamaki, Kyoto (JP); Katsuhiro Suzuki, Kyoto (JP)

(21) Appl. No.: 14/368,305

(22) PCT Filed: Feb. 6, 2012
(86) PCT No.: PCT/JP2012/052636

§ 371 Date: Jun. 24, 2014

(51) Int. Cl. G06F 17/30; G06Q 30/06

(52) U.S. Cl. CPC G06F 17/30554; G06Q 30/0627; G06Q 30/0629; G06F 17/30864
USPC 705/26.63

(57) ABSTRACT

A product search system includes a product data storage portion for storing product data, an axis item data storage portion for storing settability information for axis items and axis division numbers, a product ID storage portion for storing unique identification information of products, a two-dimensional coordinate space defining portion for defining a two-dimensional coordinate space, a distribution diagram generating portion for generating data for a distribution diagram in which product images are arranged in the coordinate space, and a product extracting portion for extracting unique identification information of products within an area of a section selected by a user, and storing the information in the product ID storage portion. Once the unique identification information is stored in the product ID storage portion, the distribution diagram generating portion generates data for a post-refinement distribution diagram in which product images for products corresponding to the stored unique identification information are relatively highlighted.

### TECHNICAL FIELD

The present invention relates to a product search system allowing the user to search for a desired product from among a plurality of pre-registered products.

BACKGROUND ART

There is conventionally known a product search system allowing the user to search for a product by inputting a search condition on a user terminal connected to a server through a network (e.g., see Patent Document 1). In this product search system, once search conditions related to product characteristic items such as product prices and specifications are inputted on the user terminal, product data for products that satisfy the inputted search conditions is extracted, and a list of the product data is generated and displayed on the user terminal. The user can view the list displayed on the user terminal and select a product to be purchased from among the listed products.

### PRIOR ART DOCUMENT

### Patent Document

Patent Document 1: Japanese Laid-Open Patent Publication No. 10-149392

### DISCLOSURE OF THE INVENTION

### Problems to be Solved by the Invention

However, in the above conventional product search system, the products that satisfy the search conditions are displayed as a list, and therefore, the user is required to compare the listed products one by one in order to select a product to be purchased ultimately. Accordingly, as the number of products that satisfy search conditions increases, there arises a problem in that it takes time to select a product to be purchased even if products are narrowed down by inputting search conditions.

The present invention has been achieved under the above circumstances, and an object thereof is to provide a product search system allowing a desired product to be selected readily and quickly.

### Solution to the Problems

To solve the above problem, the present invention provides (1) a product search system allowing a user to search for a desired product by displaying a distribution diagram with product images for a plurality of products arranged in a two-dimensional coordinate space, the system including:

a product data storage portion having product data stored for each product, the product data including unique identification information of the product, an image for the product, and feature values for the product with respect to a plurality of product characteristic items;

an axis item data storage portion having settability information and an axis division number stored for each product characteristic item, the settability information indicating whether or not the product characteristic item is settable as an axis item for either a vertical or horizontal axis of the two-dimensional coordinate space, the axis division number being set for dividing the vertical or horizontal axis into a plurality of sections;

a product ID storage portion for storing unique identification information of products arranged in the distribution diagram;

a two-dimensional coordinate space defining portion for setting product characteristic items selected by the user as axis items for the vertical and horizontal axes, setting ranges of the vertical and horizontal axes on the basis of the product characteristic items for all products whose data is stored in the product data storage portion, and defining the two-dimensional coordinate space with each of the vertical and horizontal axes divided into the sections on the basis of the axis division numbers for the product characteristic items;

a distribution diagram generating portion for deriving coordinate positions of the products in the two-dimensional coordinate space on the basis of the feature values for the product characteristic items being set as the axis items, and generating data for a distribution diagram in which product images for the products are arranged in the coordinate positions; and

a product extracting portion for extracting unique identification information of products included in an area of an arbitrary section selected by the user from among the sections or an overlapping area of two or more such arbitrary sections, and storing the unique identification information in the product ID storage portion, wherein,

once the user selects the arbitrary section and the unique identification information is stored in the product ID storage portion, the distribution diagram generating portion generates data for a post-refinement distribution diagram in which product images for products corresponding to the unique identification information stored in the product ID storage portion are relatively highlighted.

In the product search system as described in (1) above, (2) the distribution diagram generating portion preferably generates data for a post-refinement distribution diagram in which product images only for the products corresponding to the unique identification information stored in the product ID storage portion are arranged in the two-dimensional coordinate space, whereby the product images are relatively highlighted.

In the product search system as described in (1) and (2) above, (3) once a new axis item is selected in the post-refinement distribution diagram, the two-dimensional coordinate space defining portion defines a two-dimensional coordinate space in which the ranges of the vertical and horizontal axes are set on the basis of the product characteristic items being set as the axis items for all products whose data is stored in the product data storage portion, and the distribution diagram generating portion generates data for a distribution diagram in which only the product images for the products corresponding to the unique identification information stored in the product ID storage portion are arranged in the two-dimensional coordinate space.

In the product search system as described in (1) to (3) above, (4) once arbitrary product images are specified in the post-refinement distribution diagram, the product extracting portion extracts unique identification information of products corresponding to the specified product images, and stores the unique identification information in the specified product ID storage portion, and the distribution diagram generating portion corrects the data for the distribution diagram such that the product images for the products corresponding to the unique identification information stored in the specified product ID storage portion are identifiable as the specified product images.

In the product search system as described in (4) above, (5) when there is further included a display mode switching portion for switching to a display mode in which only the product images for the products corresponding to the unique identification information stored in the specified product ID storage portion are displayed, it is preferred that, once the user switches to the display mode, the two-dimensional coordinate space defining portion define a two-dimensional coordinate space in which the ranges of the vertical and horizontal axes are set on the basis of the product characteristic items being set as the axis items for all products corresponding to the unique identification information stored in the specified product ID storage portion, and the distribution diagram generating portion generate data for a distribution diagram in which product images only for products corresponding to the unique identification information stored both in the specified product ID storage portion and the product ID storage portion are arranged.

In the product search system as described in (1) to (5) above, (6) when products whose feature values for the product characteristic items being set as the axis items fall within a given preset range are arranged in the two-dimensional coordinate space, the distribution diagram generating portion preferably generates data for a distribution diagram in which product images for the products are highlighted.

In the product search system as described in (1) to (6) above, (7) when the number of product images arranged in the two-dimensional coordinate space is greater than or equal to a predetermined number, the distribution diagram generating portion preferably generates data for a distribution diagram in which symbol marks are arranged as the product images.

The product search system as described in (1) to (7) above can be configured such that (8) the distribution diagram includes a product selection frame provided for displaying a portion of the diagram at and around an arbitrary coordinate position specified by the user in an enlarged view, thereby allowing selection of a predetermined number of product images around the coordinate position, once the predetermined number of product images are selected by the product selection frame, the product extracting portion extracts unique identification information of products corresponding to the predetermined number of product images, and stores the unique identification information in the in-frame product ID storage portion, the two-dimensional coordinate space defining portion defines a two-dimensional coordinate space in which ranges of the vertical and horizontal axes are set on the basis of the product characteristic items being set as the axis items for all products corresponding to the unique identification information stored in the in-frame product ID storage portion, and the distribution diagram generating portion generates data for a distribution diagram in which product images only for the products corresponding to the unique identification information stored in the in-frame ID storage portion are arranged.

The product search system as described in (1) to (8) above can be configured such that (9) the two-dimensional coordinate space defining portion defines a two-dimensional coordinate space in which the ranges of the vertical and horizontal axes are set on the basis of a calculation result obtained by adding values resulting from a weighting calculation being performed on the basis of a predetermined order of priority after setting two or more product characteristic items as axis items for either the vertical or horizontal axis or both and normalizing possible feature values for the product characteristic items.

In the product search system as described in (1) to (9) above, (10) when there is further included a condition input screen generating portion for generating data for a search condition input screen in which to input a search condition for narrowing down products on the basis of a plurality of product characteristic items, the product extracting portion preferably extracts unique identification information of products that satisfy the search condition, and stores the unique identification information in the product ID storage portion.

In the product search system as described in (1) to (10) above, (11) there may be further included a list generating portion for generating data for a list of product data for products corresponding to arbitrary product images in the distribution diagram.

In the product search system as described in (11) above, (12) it is preferred that, when the number of product images arranged in the post-refinement distribution diagram is less than or equal to a predetermined number, the list generating portion automatically generate data for a list of product data for products corresponding to all product images in the post-refinement distribution diagram.

In the product search system as described in (1) to (12) above, (13) when the product data stored in the product data storage portion includes product characteristic items for which feature values are represented by one of two values, and there is further included a filter condition generating portion for generating data for a filter condition selection field in which to select one of the two values as the filter condition for each product characteristic item, it is preferred that, once the value for the product characteristic item is selected in the filter condition selection field, the distribution diagram generating portion generate data for a distribution diagram in which product images for products whose feature values take the other value are arranged so as to be identifiable such that the products do not satisfy the filter condition.

The product search system as described in (1) to (12) above can be configured such that (14) when the product data stored in the product data storage portion includes product characteristic items for which feature values are represented by one of two values, and there is further included a filter condition generating portion for generating data for a filter condition selection field in which to select one of the two values as the filter condition for each product characteristic item, once the value for the product characteristic item is selected in the filter condition selection field, the distribution diagram generating portion generates data for a distribution diagram in which product images for products whose feature values take the selected value are arranged so as to be identifiable such that the products satisfy the filter condition.

### EFFECT OF THE INVENTION

The present invention renders it possible to display a distribution diagram in which product characteristic items considered as important by the user are being set as axis items for the vertical and horizontal axes, so that the user can compare products both intuitively and visually in the distribution diagram, and therefore, can readily select a product to be purchased. Moreover, among the product images arranged in the distribution diagram, the present invention renders it possible to relatively highlight product images included in an area of an arbitrary section selected by the user or an overlapping area of two or more such arbitrary sections, so that product selection can be made more efficiently.

Furthermore, in the present invention, an axis section is selected (first refinement condition) so that product images are relatively highlighted in a distribution diagram, and thereafter, when axis items are changed so that a new distribution diagram is generated, product images for products that meet the first refinement condition are arranged and relatively highlighted in the generated distribution diagram. Similarly, when an axis section is selected (second refinement condition) in the distribution diagram, and thereafter, axis items are changed so that a new distribution diagram is generated, product images for products that meet both the first and second refinement conditions are arranged and relatively highlighted in the generated distribution diagram. That is, in the present invention, the number of refinement conditions increases every time a new distribution diagram is generated by selecting an axis section and changing axis items. Thus, the user can narrow down products efficiently from various viewpoints.

Therefore, the present invention renders it possible to provide a product search system allowing a desired product to be selected readily and quickly.

### BRIEF DESCRIPTION OF THE DRAWINGS

FIG. 1 is a block diagram of a product search system according to an embodiment of the present invention.

FIGS. 2A and 2B provide exemplary screens displayed on a user terminal where FIG. 2A is an initial screen, and FIG. 2B is a distribution diagram screen.

FIG. 3 is a flowchart illustrating a process by a distribution diagram generating portion.

FIG. 4 is a screen displayed on the user terminal after section selection in FIG. 2B.

FIG. 5 is a screen displayed on the user terminal after an axis item has been changed in FIG. 4.

FIG. 6 is a screen displayed on the user terminal after section selection in FIG. 5.

FIG. 7 is a screen displayed on the user terminal after product specification in FIG. 6.

FIG. 8 is a screen displayed on the user terminal after display mode switching in FIG. 7.

FIG. 9 is a screen displayed on the user terminal after product selection by a product selection frame in FIG. 2B.

FIGS. 10A to 10D describe product selection by the product extraction frame where FIGS. 10A to 10D are schematic diagrams of calculation tasks to be performed sequentially.

FIG. 11 is an exemplary screen on the user terminal, presenting a distribution diagram in which a plurality of product characteristic items are being set as axis items.

FIG. 12 is a screen on the user terminal presenting a list in FIG. 7.

FIG. 13 is a screen on the user terminal presenting a print setting window in FIG. 12.

FIG. 14 is an example of a search condition input screen displayed on the user terminal.

FIG. 15 is an example of a filter condition selection field displayed on the user terminal.

FIG. 16 is a screen displayed on the user terminal after filter condition selection in FIG. 15.

FIGS. 17A to 17E are diagrams describing the action of a filter function in the present invention.

### MODE FOR CARRYING OUT THE INVENTION

Hereinafter, a preferred embodiment of a product search system according to the present invention will be described with reference to the accompanying drawings.

### System Configuration

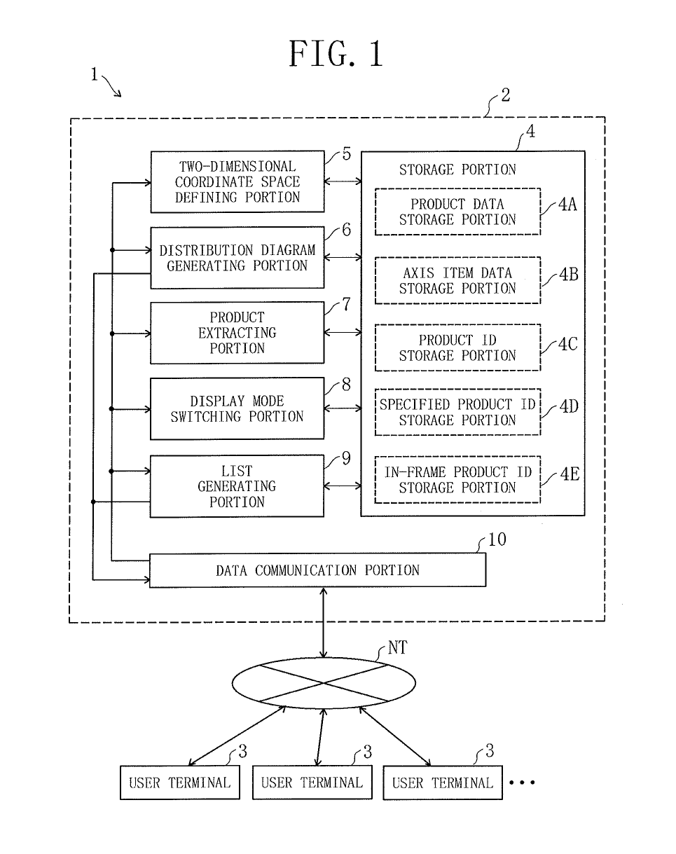

FIG. 1 illustrates a block diagram of a product search system 1 according to an embodiment of the present invention. The product search system 1 according to the present embodiment allows users to search for desired products from among a plurality of pre-registered products (in the present embodiment, used cars) on user terminals 3 connected to a server 2 through a network NT, as shown in the figure.

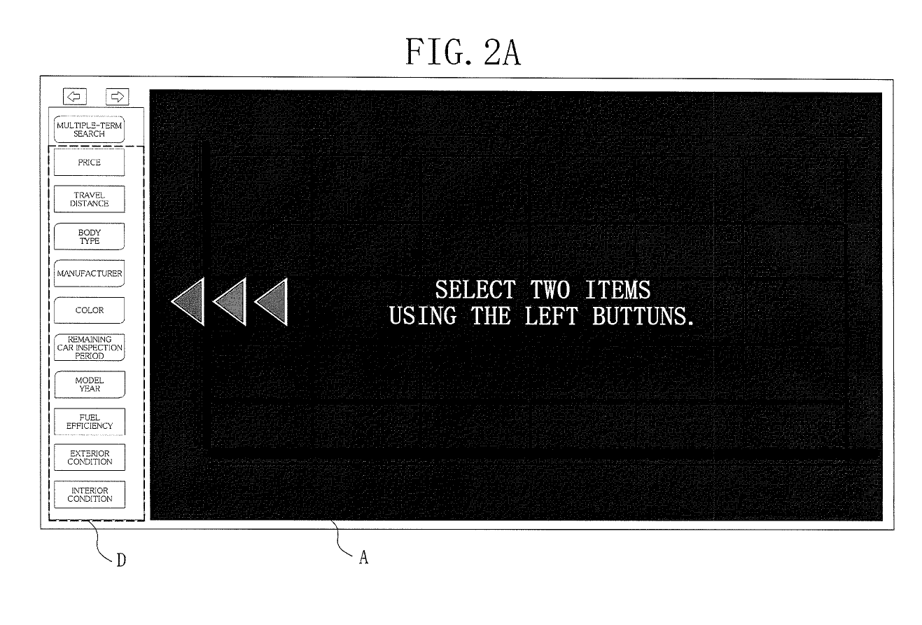

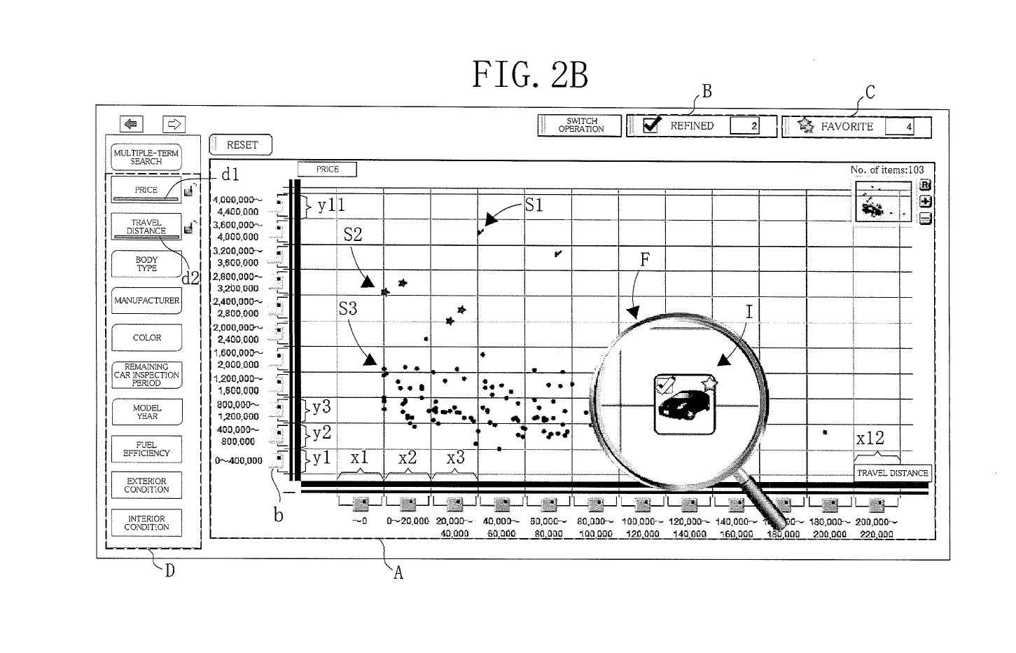

FIGS. 2A and 2B provide exemplary screens displayed on the user terminal 3 by the product search system 1 where part FIG. 2A is an initial screen in which to select axis items for the vertical and horizontal axes, and part FIG. 2B is a distribution diagram screen to be displayed after selection of the axis items.

Product characteristic items, which can be set as axis items for the vertical and horizontal axes of the distribution diagram, are listed in area D on the left side of the initial screen shown in FIG. 2A. From among the listed product characteristic items, for example, when “price” and “travel distance” are sequentially selected, a distribution diagram with “price” and “travel distance” being set as the axis items for the vertical and horizontal axes, respectively, is displayed on the user terminal 3 (see FIG. 2B).

In the distribution diagram screen shown in FIG. 2B, a plurality of product images are arranged as symbol marks S1 to S3 in area A at the center. The vertical and horizontal axes of the distribution diagram are divided into a plurality of sections (y1 to y11 and x1 to x12). The symbol marks S1 to S3 are of the following three types: check mark S1 for indicating a product specified as “refined (referred to below as “checked”)” to be described later; star mark S2 for indicating a product specified as “favorite”; and circle mark S3 for indicating a product specified neither as “checked” nor “favorite”. The number of products specified as “checked” and the number of products specified as “favorite” are displayed in areas B and C, respectively, on the top right of the screen.

Furthermore, the distribution diagram includes a product selection frame F provided for displaying a portion of the distribution diagram at and around an arbitrary coordinate position in an enlarged view, thereby allowing selection of a predetermined number of products around the coordinate position. The screen in FIG. 2B is in a state before a predetermined number of products are selected by the product selection frame F. A product image within the product selection frame F (i.e., within the lens of a magnifier) is displayed as a schematic product image I. The product selection frame F will be described in detail later.

As in FIG. 2A, the product characteristic items are listed in area D on the left side. The user can readily change the product characteristic items being set as axis items, by clicking a listed product characteristic item using a mouse pointer or suchlike. Basically, in the present embodiment, the first product characteristic item clicked becomes the axis item for the vertical axis, and the second product characteristic item clicked becomes the axis item for the horizontal axis. Furthermore, identification indicators are provided for easy identification of whether the clicked product characteristic items are being set on either the vertical or horizontal axis; the button for the axis item “price” being set for the vertical axis has bar dl displayed in the same color as the vertical axis (e.g., blue) at the bottom, and the button for the axis item “travel distance” being set for the horizontal axis has bar d2 displayed in the same color as the horizontal axis (e.g., purple) at the bottom.

Referring back to FIG. 1, the server 2 of the product search system 1 includes a storage portion 4, a two-dimensional coordinate space defining portion 5, a distribution diagram generating portion 6, a product extracting portion 7, a display mode switching portion 8, a list generating portion 9, and a data communication portion 10.

The storage portion 4 includes a product data storage portion 4A, an axis item data storage portion 4B, a product ID storage portion 4C, a specified product ID storage portion 4D, and an in-frame product ID storage portion 4E.

The product data storage portion 4A has product data previously acquired and stored for each product, including unique product identification information (referred to below as “IDs”), product images, and product-related feature values for a plurality of product characteristic items. The product data is acquired by regularly accessing a database owned by product sellers or received as XML files from product sellers.

The axis item data storage portion 4B has settability information stored for each product characteristic item for products whose data is stored in the product data storage portion 4A, and the settability information indicates whether the product characteristic item is either “settable” or “not settable” as an axis item. “Settable” product characteristic items are listed on the user terminal 3 (see area D in FIGS. 2A and 2B). Furthermore, the axis item data storage portion 4B has axis division numbers for the vertical and horizontal axes stored for each product characteristic item. The axis division number varies among the product characteristic items, for examples, 11 for the product characteristic item “price”, and also 12 for the product characteristic item “travel distance” (see area A in FIG. 2B). The axis division number can be set arbitrarily on the server 2 in accordance with possible feature values for the product characteristic item, the number of product images included in a section, viewability of the distribution diagram, or the like, and the axis division number for the same product characteristic item may vary between the axis item being for the vertical axis and the axis item being set for the horizontal axis.

The product ID storage portion 4C stores IDs of products arranged in the distribution diagram. More specifically, the stored IDs are those of the products included in an area of an arbitrary section selected on the user terminal 3 or an overlapping area of two or more such arbitrary sections. The user can select a section arbitrarily by clicking a numerical value or character string that represents a feature value for a section, or a button b positioned near the numerical value or character string (see area A in FIG. 2B), using the mouse pointer or suchlike.

The specified product ID storage portion 4D stores IDs of products specified as “checked” on the user terminal 3 and IDs of products specified as “favorite”, independently of each other.

The in-frame product ID storage portion 4E stores IDs of products selected by the product selection frame F or a selection frame displayed by a drag-and-drop operation using the mouse pointer.

Once product characteristic items are selected on the user terminal 3, the two-dimensional coordinate space defining portion 5 sets the product characteristic items as the axis items for the vertical and horizontal axes, divides each of the vertical and horizontal axes into a plurality of sections on the basis of the axis division numbers for the product characteristic items, and further, sets the ranges of the vertical and horizontal axes in accordance with the product characteristic items being set as the axis items.

In the case where the feature values for the product characteristic items being set as the axis items can be represented by numerical values as in the case of “price” or “travel distance”, the ranges of the vertical and horizontal axes vary between display modes to be described later. More specifically, the ranges of the vertical and horizontal axes are set so as to include: (1) in the case of a “normal display mode” in which product images for all products are displayed, the feature values stored in the product data storage portion 4A for the product characteristic items being set as the axis items with respect to the products; (2) in the case of a “checked product display mode” (or “favorite product display mode”) in which product images only for the products specified as “checked” (or “favorite”) are displayed, the feature values for the product characteristic items being set as the axis items with respect to all of the “checked” (or “favorite”) products; or (3) in the case of a “magnified view mode” in which product images only for a predetermined number of selected products are displayed, the feature values for the product characteristic items being set as the axis items with respect to the predetermined number of selected products.

On the other hand, when the feature values for the product characteristic items being set as the axis items cannot be represented by numerical values as in the case of “color” or “manufacturer”, the ranges of the vertical and horizontal axes are set so as to include: in the case of (1) the “normal display mode” or (2) the “checked product display mode” (or the “favorite product display mode”), the feature values stored in the product data storage portion 4A for the product characteristic items being set as the axis items with respect to all products; or in the case of (3) the “magnified view mode”, the feature values for the product characteristic items being set as the axis items with respect to a predetermined number of selected products.

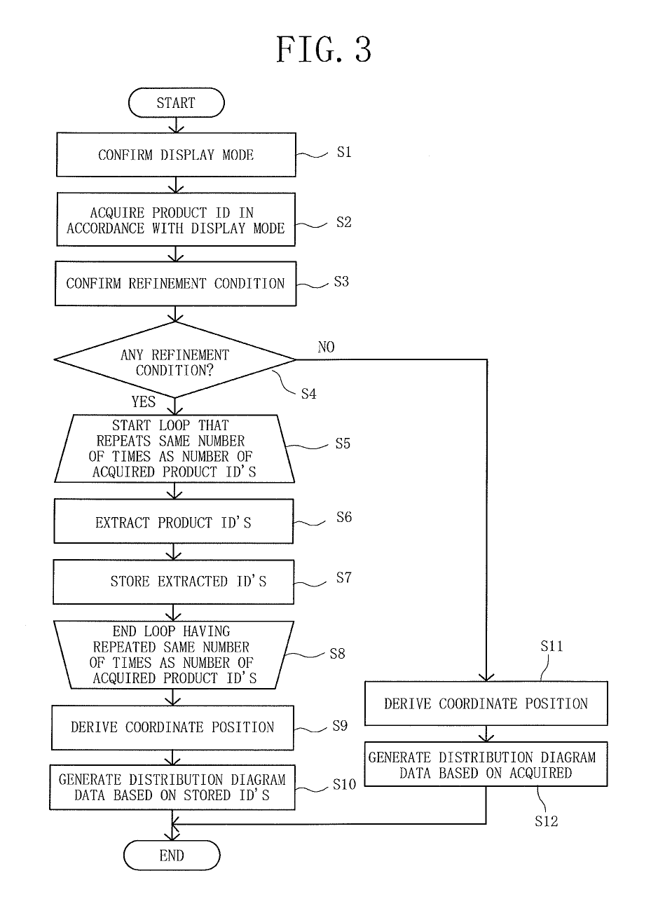

FIG. 3 is a flowchart illustrating a process by the distribution diagram generating portion 6. Selection of a section on the vertical or horizontal axis, a change of axis items, a change of display modes, or the like, on the user terminal 3 causes the distribution diagram generating portion 6 to perform the process shown in FIG. 3. In other words, the distribution diagram generating portion 6 performs the process shown in FIG. 3 when the need to generate data related to the distribution diagram arises.

As shown in the figure, the distribution diagram generating portion 6 initially confirms the display mode (S1), and then acquires product IDs in accordance with the display mode (S2). More specifically, in the case of the “normal display mode”, all product IDs stored in the product data storage portion 4A are acquired; in the case of the “checked product display mode” (or the “favorite product display mode”), all product IDs stored in the specified product ID storage portion 4D are acquired; or in the case of the “magnified view mode”, all product IDs stored in the in-frame product ID storage portion 4E are acquired.

Subsequent to the acquisition of the product IDs in accordance with the display mode, an attempt is made to confirm if there is any refinement condition (S3).

The refinement condition refers to a condition for an area of an arbitrary section selected on the user terminal 3 or an overlapping area of two or more such arbitrary sections, i.e., a condition for feature values for product characteristic items. For example, in the case where sections y2, y3, x2, and x3 are selected in the distribution diagram shown in FIG. 2B, the refinement condition is such that “the price ranges from ¥400,000 to ¥1,200,000 (either in section y2 or y3), and the travel distance ranges from 0 to 40,000 km (either in section x2 or x3)” (condition 1). That is, the refinement condition is a logical sum of the feature values for selected sections when the selected sections are on the same axis, or a logical product of the feature values for selected sections when the selected sections are on different axes. Note that a search condition inputted via an instant-search setting window to be described later is also a refinement condition.

In the case where a refinement condition has been confirmed (YES in S4) as a result of the attempt at refinement condition confirmation, a verification is started as to whether the feature values for products corresponding to the product IDs acquired in step S2 satisfy the refinement condition (S5).

The IDs of the products whose feature values satisfy the refinement condition are extracted by the product extracting portion 7 to be described later (S6), and stored in the product ID storage portion 4C (S7). Thereafter, upon completion of the verification for the product IDs acquired in step S2 (S8), coordinate positions of the products corresponding to the IDs stored in the product ID storage portion 4C are derived (S9), and data is generated for a distribution diagram (a post-refinement distribution diagram) in which product images only for the products corresponding to the IDs stored in the product ID storage portion 4C are arranged in the coordinate positions (S10). As a result, the user terminal 3 displays the distribution diagram in which only the product images for the products corresponding to the IDs stored in the product ID storage portion 4C are arranged.

On the other hand, in the case where no refinement condition has been confirmed (NO in S4) as a result of the attempt at refinement condition confirmation, the coordinate positions of all products corresponding to the product IDs acquired in step S2 are derived (S11), and data is generated for a distribution diagram in which product images for all of the products are arranged in the coordinate positions (S12). In this case, the user terminal 3 displays the distribution diagram in which the product images for all of the products are arranged.

Referring back to FIG. 1, the product extracting portion 7 extracts product IDs and stores the IDs in the storage portion 4. More specifically, the product extracting portion 7 performs extraction of IDs of products that satisfy the refinement condition as well as storage of the IDs in the product ID storage portion 4C (see S6 and S7 in FIG. 3), extraction of IDs of products specified by “checked” (or “favorite”) as well as storage of the IDs in the specified product ID storage portion 4D, or extraction of IDs of products selected by the product selection frame F or a selection frame as well as storage of the IDs in the in-frame product ID storage portion 4E.

The display mode switching portion 8 switches the display modes among “normal display mode”, “checked product display mode”, “favorite product display mode”, and “magnified view mode”.

The list generating portion 9 generates data for a list of product data for all products displayed in the distribution diagram or arbitrary products selected by the user.

The data communication portion 10 transmits, for example, data for the distribution diagram and the list to the user terminal 3, and receives, for example, the refinement condition from the user terminal 3.

### 1. Refinement Function by Changing Axis Items

Next, a “refinement function by changing axis items” will be described.

The “refinement function by changing axis items” is a function for, when axis items have been changed in a distribution diagram after section selection, generating a distribution diagram in which the refinement condition before the changing of the axis items is reflected.

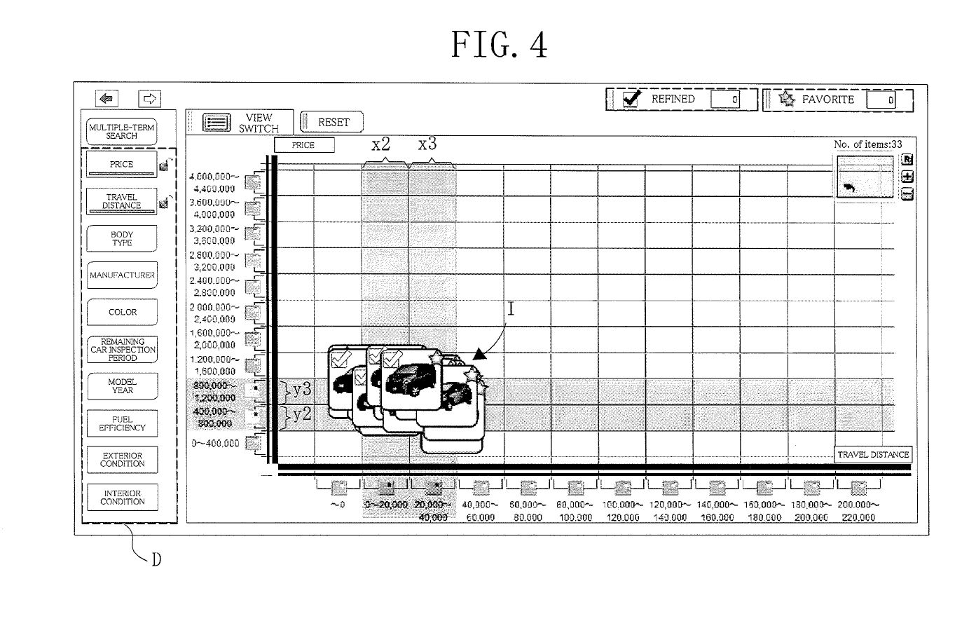

FIG. 4 is a screen displayed on the user terminal after section selection in FIG. 2B. In the distribution diagram shown in FIG. 4, “price” is being set as the axis item for the vertical axis, “travel distance” is being set as the axis item for the horizontal axis, and further, sections y2 and y3 on the vertical axis and sections x2 and x3 on the horizontal axis are being selected. Accordingly, the refinement condition in the distribution diagram shown in FIG. 4 is condition 1 mentioned above. Note that in FIG. 4, the display mode is assumed to be “normal display mode”.

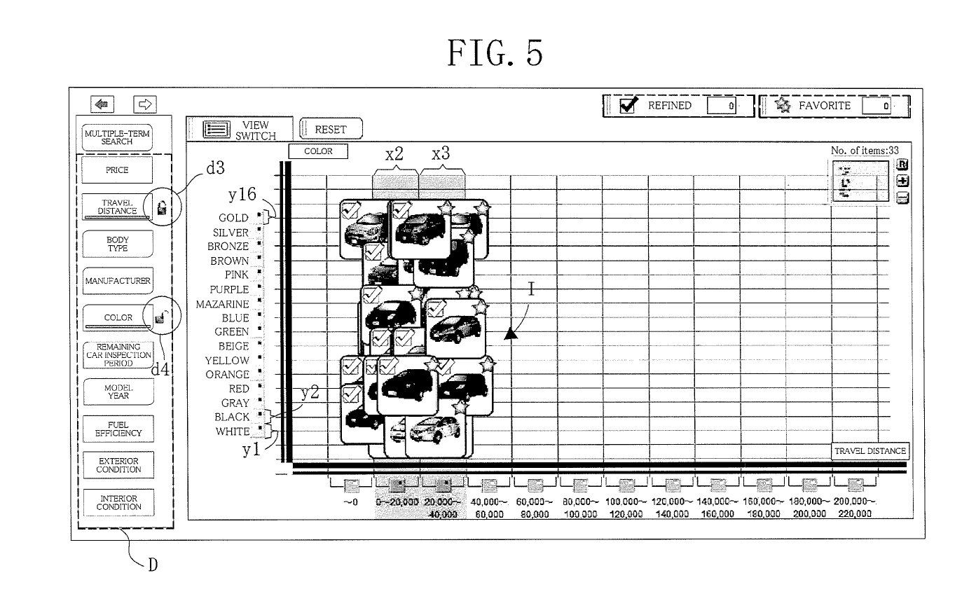

FIG. 5 is a screen displayed on the user terminal 3 after only the axis item for the vertical axis has been changed from “price” to “color” in FIG. 4. As shown in this figure, in the case where only the product characteristic item that is the axis item for the vertical axis is changed, the user clicks the “color” button after locking the “travel distance” button displayed in area D by clicking a lock button d3 positioned to the right thereof using the mouse pointer or suchlike. At this time, a lock button positioned to the right of the axis item “price” being set for the vertical axis is OFF by default, and therefore, when the “color” button is clicked, the axis item for the vertical axis is changed from “price” to “color”. Note that after the change, a lock button d4 in OFF state is displayed to the right of “color”.

Upon the change of the axis item, the two-dimensional coordinate space defining portion 5 sets “color” and “travel distance” selected on the user terminal 3 as the axis items for the vertical and horizontal axes, respectively, and further, on the basis of the axis division numbers 16 (y1 to y16) and 12 (x1 to x12) for “color” and “travel distance” previously stored in the axis item data storage portion 4B, the two-dimensional coordinate space defining portion 5 sets the number of sections for each of the vertical and horizontal axes and also sets the ranges of the vertical and horizontal axes so as to include feature values stored in the product data storage portion 4A for all products with respect to “color” and “travel distance”.

The change of the axis item causes the distribution diagram generating portion 6 to perform the process shown in FIG. 3. More specifically, the distribution diagram generating portion 6 confirms that the display mode is “normal display mode”, acquires all product IDs stored in the product data storage portion 4A in accordance with the display mode, and starts a verification as to whether or not the feature values for all of the products with respect to “price” and “travel distance” satisfy the refinement condition (condition 1) in the distribution diagram shown in FIGS. 4 (S1 to S5 in FIG. 3). The IDs of the products whose feature values satisfy condition 1 are extracted by the product extracting portion 7, and stored in the product ID storage portion 4C (S6 and S7 in FIG. 3). Upon completion of the verification as to whether condition 1 is satisfied or not, the distribution diagram generating portion 6 derives coordinate positions of products corresponding to the IDs stored in the product ID storage portion 4C, and generates data for a distribution diagram in which product images only for the products are arranged in the coordinate positions (S8 to S10 in FIG. 3). As a result, the user terminal 3 displays a distribution diagram in which only the product images for the 33 products that satisfy condition 1 are arranged.

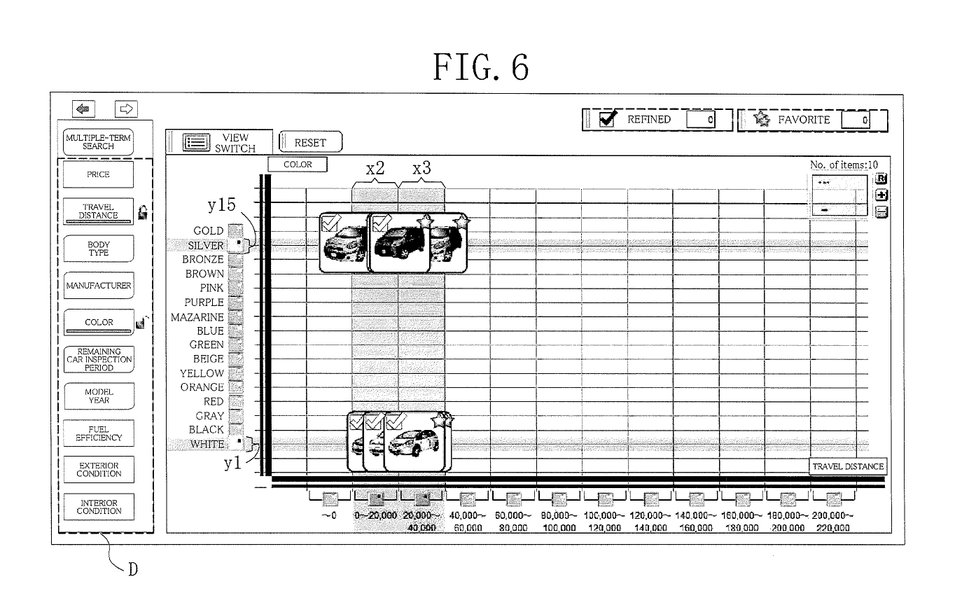

FIG. 6 is a screen displayed on the user terminal 3 after section selection in FIG. 5. In the distribution diagram shown in FIG. 6, section y1 (for the feature value “white”) and section y15 (for the feature value “silver”) on the vertical axis are being selected on the user terminal 3. Accordingly, in addition to condition 1, another refinement condition such that “the color is ‘white’ or ‘silver”’ (condition 2) is confirmed in step S3 of FIG. 3. In steps S5 to S8 of FIG. 3, IDs of products that satisfy both conditions 1 and 2 are extracted and stored in the product ID storage portion 4C. As a result, the IDs stored in the product ID storage portion 4C during the generation of the distribution diagram shown in FIG. 5 are replaced by the IDs stored anew. Moreover, data is generated for a distribution diagram in which product images only for products corresponding to the IDs stored in the product ID storage portion 4C are arranged. As a result, the user terminal 3 displays the distribution diagram shown in FIG. 6 in which only the product images for the ten products that satisfy both conditions 1 and 2 are arranged.

In this manner, in the product search system 1 with the “refinement function by changing axis items”, the number of refinement conditions increases every time a new distribution diagram is generated by selecting an axis section and changing axis items. Thus, the user can narrow down products efficiently from various viewpoints.

### 2. Checked Function and Favorite Function

Next, a “checked function” and a “favorite function” will be described.

The “checked function” and the “favorite function” are functions for visually differentiating products specified as “checked” and “favorite” on the user terminal 3 from other products in a distribution diagram.

The “checked function” is volatile, whereas the “favorite function” is nonvolatile. That is, the product specified as “checked” is no longer marked as “checked” once the user terminal 3 is disconnected from the server 2, but the product specified as “favorite” remains in “favorite” status even when the connection with the server 2 is lost.

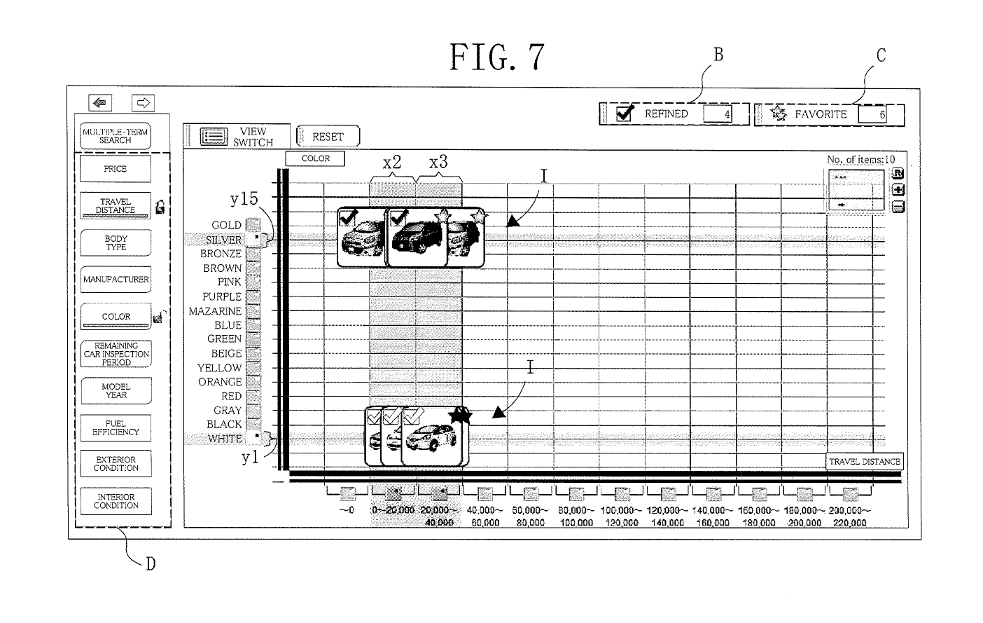

FIG. 7 is a screen displayed on the user terminal 3 after six products in section y1 on the vertical axis in FIG. 6 have been specified as “favorite”, and four products in section y15 as “checked”.

As shown in this figure, for the schematic images I for the products specified as “favorite”, the color of their star marks positioned on the upper right has changed from colorless (transparent) to yellow, whereas for the schematic images I for the products specified as “checked”, the color of their check marks positioned on the upper left has changed from colorless (transparent) to green. Accordingly, the user can visually distinguish the products specified as “checked” or “favorite” in the distribution diagram. Note that in the case where symbol marks are displayed as product images, as shown in FIG. 2B, products specified as “favorite” are represented by star marks S2, and products specified as “checked” by check marks S1.

In the case where products are specified as “checked” or “favorite”, as shown in FIG. 7, the product extracting portion 7 extracts IDs of the products specified as “checked” or “favorite”, and stores the IDs for “checked” and “favorite” independently of each other in the specified product ID storage portion 4D.

Once the IDs are stored in the specified product ID storage portion 4D, the distribution diagram generating portion 6 corrects data for the distribution diagram, rather than generates data for a new distribution diagram (i.e., rather than performs the process of FIG. 3), so as to change the color of the check marks or star marks in the product images for the products specified as “checked” or “favorite” and corresponding to the IDs stored in the specified product ID storage portion 4D.

FIG. 8 is a screen displayed on the user terminal 3 after the display mode has been switched from “normal display mode” to “favorite product display mode” in FIG. 7.

Once the display mode has been switched to “favorite product display mode”, the two-dimensional coordinate space defining portion 5 sets the ranges of the vertical and horizontal axes on the basis of the product characteristic items “color” and “travel distance” for the products corresponding to the IDs stored in the specified product ID storage portion 4D. More specifically, since the axis item for the vertical axis is “color”, the range of the vertical axis is set so as to include feature values stored in the product data storage portion 4A for all products with respect to “color”. On the other hand, since the axis item for the horizontal axis is “travel distance”, the range of the horizontal axis is set so as to include feature values with respect to “travel distance” for all of the six products that correspond to the IDs stored in the specified product ID storage portion 4D. Accordingly, the range of the horizontal axis shown in FIG. 7 spans sections x2 and x3.

The switching between the display modes causes the distribution diagram generating portion 6 to perform the process shown in FIG. 3. In FIG. 8, the display mode is “favorite product display mode”, and therefore, in step S2 of FIG. 3, the distribution diagram generating portion 6 acquires the IDs of all of the six products specified as “favorite” that are stored in the specified product ID storage portion 4D. Furthermore, the refinement conditions confirmed in step S3 of FIG. 3 are conditions 1 and 2 mentioned above, and therefore, in steps S5 to S8 of FIG. 3, a verification is made as to whether all of the six products specified as “favorite” satisfy conditions 1 and 2. All of the six products satisfy both conditions 1 and 2, the IDs of the six products are stored in the product ID storage portion 4C, and data is generated for a distribution diagram in which product images only for the six items are arranged. As a result, the user terminal 3 displays the distribution diagram in which only the product images for the six items are arranged, so that the user can select a desired product from among the products specified as “favorite”.

Note that even in the case where the display mode is switched to “checked product display mode”, a similar process to the above is performed, so that the user terminal 3 displays a distribution diagram in which images only for products specified as “checked” are arranged.

### 3. Magnifier Enlargement Function

Next, a “magnifier enlargement function” will be described.

The “magnifier enlargement function” is a function related to the product selection frame F for displaying a portion at and around an arbitrary coordinate position specified by the user terminal 3 in an enlarged view, thereby allowing selection of a predetermined number of product images around the specified arbitrary coordinate position.

The product selection frame F is presented in the distribution diagram as a magnifier-like image, as shown in FIG. 2B, so as to display a portion within the frame F in an enlarged view and also a product image within the frame F as a schematic image I.

The number of product images displayed within the product selection frame F differs from the number of products selected using the frame F. More specifically, in the product search system 1 according to the present embodiment, the number of product images displayed within the product selection frame F is one, but the number of selectable products is 49. Note that the number of selectable products can be set arbitrarily on the server 2 in accordance with processing speed.

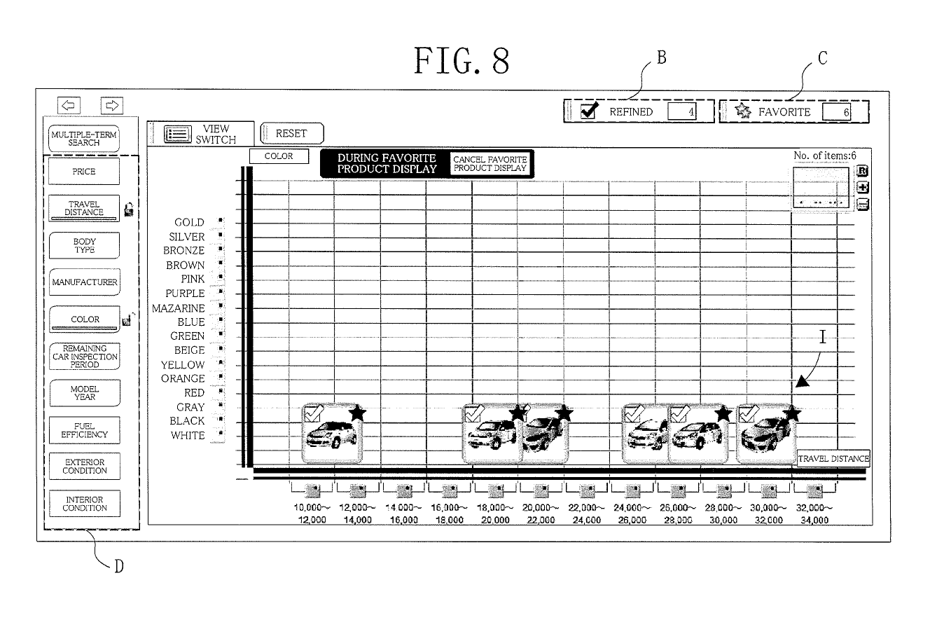

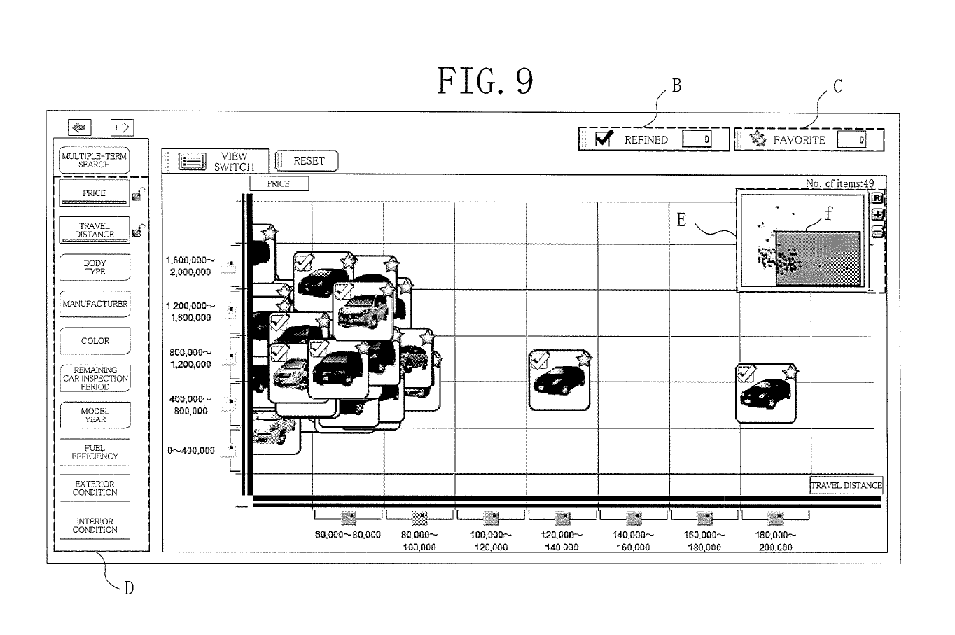

FIG. 9 is a screen displayed on the user terminal 3 after 49 products around an arbitrary coordinate position within the product selection frame F in FIG. 2B have been selected by clicking on the coordinate position using the mouse pointer. In the distribution diagram shown in FIG. 9, an area including product images only for the 49 products is displayed in an enlarged view, and a reduced image E for the distribution diagram shown in FIG. 2B (the distribution diagram showing the overall image before the selection) is positioned on the upper right. The reduced image E includes a virtual frame f indicating the area selected by the product selection frame F.

Once products are selected by the product selection frame F, the display mode is switched to “magnified view mode”, the product extracting portion 7 extracts product IDs corresponding to the selected product images, and the extracted IDs are stored in the in-frame product ID storage portion 4E.

The two-dimensional coordinate space defining portion 5 sets the ranges of the vertical and horizontal axes on the basis of the feature values with respect to the product characteristic items “price” and “travel distance” for products corresponding to the IDs stored in the in-frame product ID storage portion 4E.

The selection of the products by the product selection frame F causes the distribution diagram generating portion 6 to perform the process shown in FIG. 3. In FIG. 9, the display mode is “magnified view mode”, and therefore, in step S2 of FIG. 3, the distribution diagram generating portion 6 acquires product IDs stored in the in-frame product ID storage portion 4E. Furthermore, there has been no refinement condition confirmed in step S3 of FIG. 3 (NO in S4 of FIG. 3), and therefore, the distribution diagram generating portion 6 derives coordinate positions of products corresponding to the acquired IDs (S11 of FIG. 3), and generates data for a distribution diagram in which product images for the products are arranged in the coordinate positions (S12 of FIG. 3). As a result, the user terminal 3 displays the distribution diagram in which only the product images selected by the product selection frame F are arranged, so that the user can select a desired product from among the products.

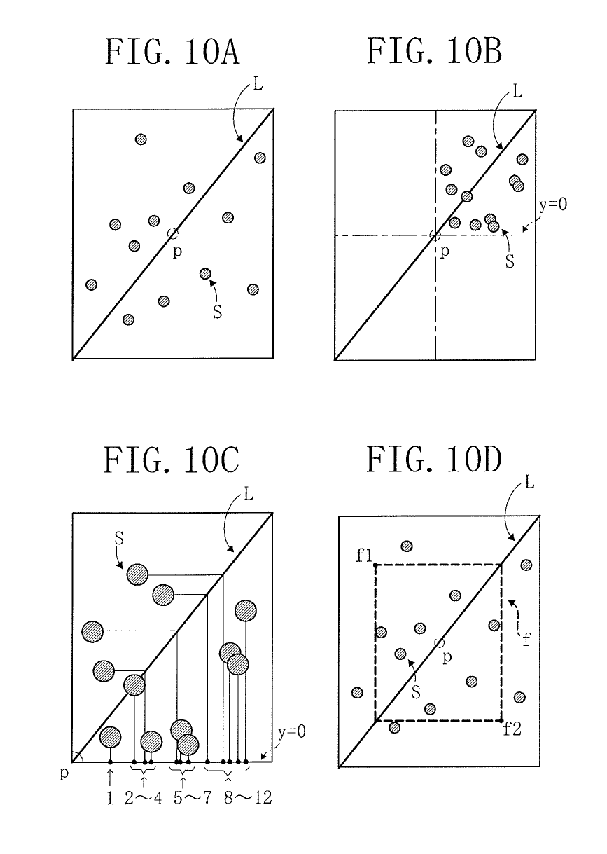

FIGS. 10A to 10D provide schematic diagrams describing product selection (within the area of the virtual frame f) by the product extraction frame F. In FIGS. 10A to 10D, seven products (represented by symbol marks S) are selected by the virtual frame f.

Initially, the angle α of a diagonal line L of a distribution diagram is calculated (see FIG. 10A), the coordinate position (Dx[i],Dy[i]) of each product where the coordinate position (px,py) of a mouse pointer p is at the origin is calculated on the basis of the coordinate position (px,py) of the mouse pointer p and the coordinate position (dx[i],dy[i]) of the product.

Subsequently, the absolute value of the coordinate position (Dx[i],Dy[i]) is calculated for each product, and the coordinate position (Dx[i],Dy[i]) of the product is converted into a coordinate position in the first quadrant (see FIG. 10B). After the coordinate position (Dx[i],Dy[i]) of each product has been converted into a coordinate position in the first quadrant, the angle Da[i] Dy′[i]/Dx′[i]) of a line extending between the coordinate position (Dx′[i],Dy′[i]) after conversion and the coordinate position (px,py) of the mouse pointer p is calculated for each product.

Once the angle Da[i] is calculated for each product, a coordinate position (X[i],0) at which the minimum virtual frame f[i] to enclose the product crosses the horizontal axis (y=0) of the two-dimensional coordinate system is calculated on the basis of Da[i]. More specifically, the coordinate position (X[i],0) is X[i] =Dy′[i]/a where Da[i]>a, or X[i]=Dx′[i] where Da[i] =a or Da[i]<a (see FIG. 10C).

Once the coordinate positions (X[i],0) for the virtual frame X[i] are calculated, the seventh smallest (X[7],0) among the calculated X[i] values is set as the coordinate position at which the virtual frame f crosses the horizontal axis (y=0) of the two-dimensional coordinate system. Note that the products that respectively correspond to the smallest to the seventh smallest (X[1],0) to (X[7],0) among the calculated X[i] values are within the virtual frame f.

Subsequently, as shown in FIG. 10D, the coordinate positions f1(x1 ,y1) and f2(x2,y2) at the upper left and the lower right, respectively, of the virtual frame f are calculated. More specifically, x1=px−X, y1=py+Y, x2=px+X, and y2=py−Y. Note that X and Y in the above equations are X=Dy′[7]/a and Y=Dy′[7] where Da[7]>a, or X=Dx′[7] and Y=a Dx′[7] where Da[7]=a or Da[7]<a. By calculating the coordinate positions f1(x1,y1) and f2(x2,y2), the size of the virtual frame f can be set and the virtual frame f is arranged on the reduced image E (see area E in FIG. 9).

As described above, the “magnifier enlargement function” of the product search system 1 renders it possible to reliably extract data for a predetermined number of products, so that the time taken for product search can be further shortened.

### 4. Multiple-term Search Function

Next, a “multiple-term search function” will be described.

The “multiple-term search function” is a function for setting a plurality of product characteristic items as axis items for either the vertical or horizontal axis or both and generating data for a distribution diagram comprehensively taking account of the user's preference.

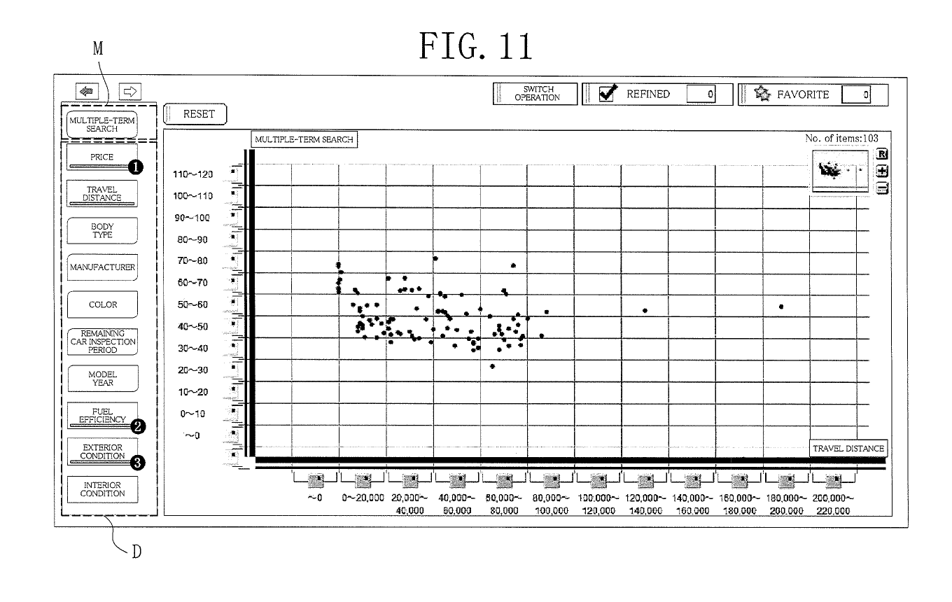

FIG. 11 is an exemplary screen on the user terminal 3, presenting a distribution diagram in which the axis items “price”, “fuel efficiency”, and “exterior condition” are being set on the vertical axis, and the axis item “travel distance” is being set on the horizontal axis.

As shown in the figure, a multiple-term search button M for effecting the “multiple-term search function” is positioned in area D where the product characteristic items are listed. By clicking the button M using the mouse pointer or suchlike, it is rendered possible for the user to select a plurality of product characteristic items as axis items while setting an order of priority. In FIG. 11, the order of priority is “price”, “fuel efficiency”, and “exterior condition”, and the number that indicates the priority of each product characteristic item is assigned at the lower right of the button for that item.

In the case where the axis items “price”, “fuel efficiency”, and “exterior condition” are selected for the vertical axis on the user terminal 3, the two-dimensional coordinate space defining portion 5 defines a two-dimensional coordinate space in which the range of the vertical axis is set on the basis of a calculation result obtained by adding values resulting from a weighting calculation being performed on the basis of the order of priority after normalizing possible feature values for the product characteristic items.

The distribution diagram generating portion 6 derives coordinate positions of products in the two-dimensional coordinate space on the basis of the calculation result and the axis item “travel distance” for the horizontal axis (step S9 or S11 of FIG. 3), and generates data for a distribution diagram in which product images are arranged in the coordinate positions. As a result, the user terminal 3 displays the distribution diagram shown in FIG. 11.

### 5. List View Function

Next, a “list view function” will be described.

The “list view function” is a function for generating data for a list of product data for use in comparison in text format, regarding all products arranged in a distribution diagram. The list data is generated by the list generating portion 9.

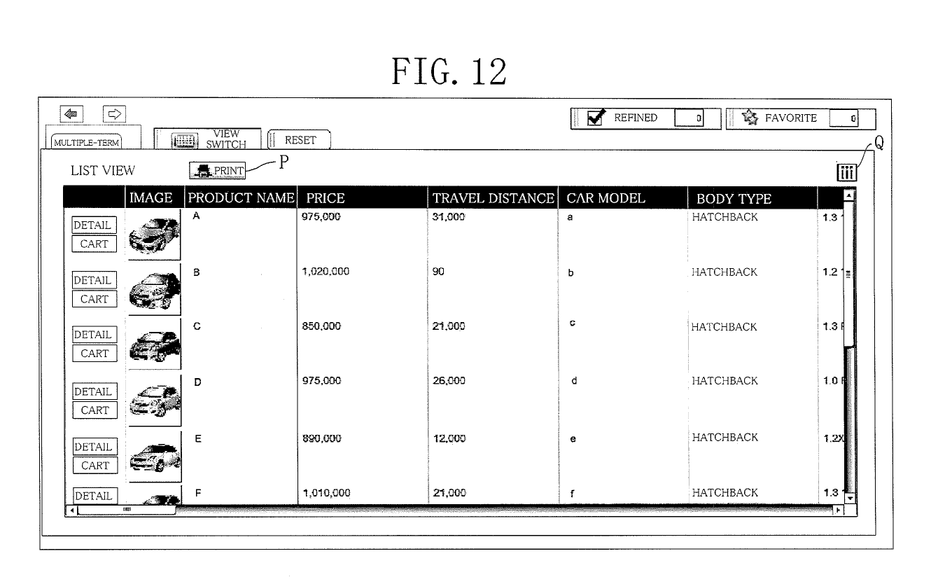

FIG. 12 is a screen on the user terminal 3 horizontally listing product data for all products arranged in the distribution diagram of FIG. 7. The horizontal list includes a print button P for displaying a print setting window to be described later and a list view switch button Q for switching to a vertical list presenting the product data vertically.

The horizontal list is displayed by the user operating the user terminal 3, but in the case where the number of product images arranged in the distribution diagram is less than or equal to a predetermined number (e.g., 10 or less), the list generating portion 9 may generate data for a list of product data for all of the ten products and the list may be displayed automatically on the user terminal 3.

### 6. Print Function

Next, a “print function” will be described.

The “print function” is a function for selecting and outputting only necessary information (feature values for product characteristic items) from product data in a list generated by the list generating portion 9.

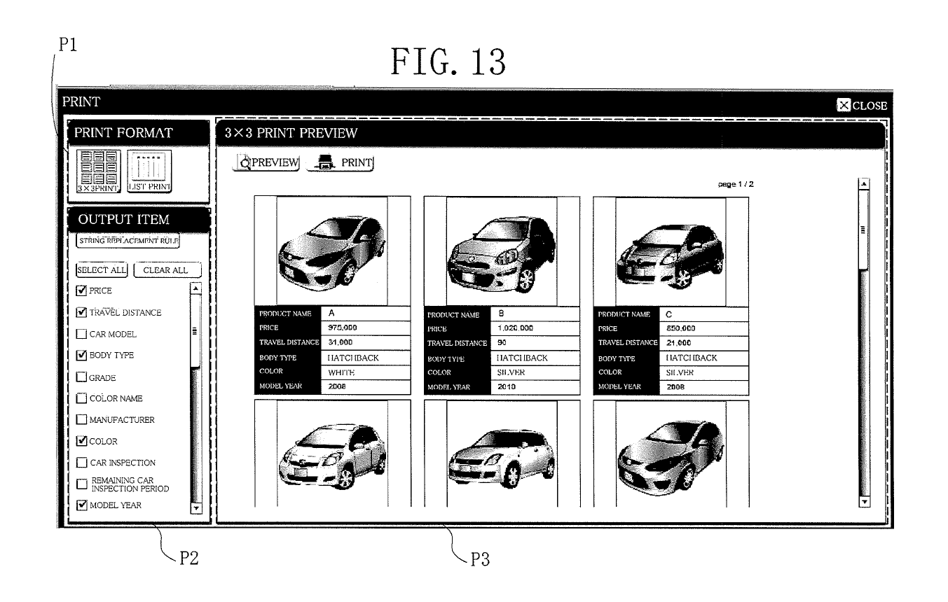

FIG. 13 is a screen on the user terminal 3 presenting a print setting window as a result of the print button P arranged in the horizontal list of FIG. 12 having been clicked. The print setting window consists of a print format selecting portion P1, an output item selecting portion P2, and a preview portion P3. The print format selecting portion P1 allows a print format to be selected from “3×3 print” for displaying three pieces of product data at a time and “list print” for displaying product data in list format. The output item selecting portion P2 allows product characteristic items to be selected from the product data for output. The preview portion P3 displays a list generated in accordance with the print format selected in the print format selecting portion P1 and the product characteristic items selected in the output item selecting portion P2. In FIG. 13, the print format “3×3 print” is being selected, and the product characteristic items “price”, “travel distance”, “body type”, “color”, and “model year” are being selected.

### 7. Drag-And-Drop Range Selection Function

Next, a “drag-and-drop range selection function” will be described.

The “drag-and-drop range selection function” is a function for selecting a predetermined number of product images from among the product images arranged in a distribution diagram, using a selection frame displayed by a drag-and-drop operation using the mouse pointer.

The “drag-and-drop range selection function” differs from the “magnifier enlargement function” in that the size of the selection frame can be specified arbitrarily, and the number of selectable product images can be adjusted arbitrarily.

The “drag-and-drop range selection function” allows the user having selected products by the selection frame to further select “magnified view” for displaying magnified images of the selected products, and “batch check” (or “batch favorite”) for collectively specifying the selected products as “checked” (or “favorite”).

In the case where the “magnified view” has been selected, the display mode is switched to “magnified view mode”, and the product extracting portion 7 extracts and stores IDs of the products selected by the selection frame in the in-frame product ID storage portion 4E. The switching of the display mode to “magnified view mode” causes the distribution diagram generating portion 6 to perform the process shown in FIG. 3.

On the other hand, in the case where “batch check” (or “batch favorite”) has been selected, the product extracting portion 7 extracts and stores IDs of the products selected by the selection frame in the specified product ID storage portion 4D, and the distribution diagram generating portion 6 corrects the data for the distribution diagram such that the product images for the products specified by “batch check” (or “batch favorite”) are highlighted.

In the product search system 1, the “drag-and-drop range selection function” and the “magnifier enlargement function” can be set and arbitrarily switched therebetween on the user terminal 3, and in the case where the “drag-and-drop range selection function” has been set, the product selection frame F is not shown in the distribution diagram.

### 8. Image View Switching Function

Next, an “image view switching function” will be described.

The “image view switching function” is a function for switching symbol marks S1, S2, and S3 for product images arranged in a distribution diagram to schematic images I in accordance with a preset number of product images to be arranged.

In the product search system 1 according to the present embodiment, the number for the switching is set at 49; in the case where the number of product images arranged in the distribution diagram is 50 or more, the product images are displayed as symbol marks S1, S2, and S3, whereas in the case where the number of product images arranged in the distribution diagram is 49 or less, the product images are displayed as schematic images I.

Furthermore, in the product search system 1 according to the present embodiment, the number of product images to be selected by the product selection frame F is set at 49, and therefore, the product images selected by the product selection frame F are always displayed as schematic images I.

### 9. Recommend Function

Next, a “recommend function” will be described.

The “recommend function” is a function for highlighting product images for products recommended to the user. Whether or not the product images can be highlighted by the “recommend function” is determined by the product characteristic item being set as an axis item.

For example, in the case where a product characteristic item such as “exterior condition” or “model year”, which is typically considered better with a higher feature value, is being set as an axis item for either or both of the axes, products with high feature values are highlighted, and on the other hand, in the case where a product characteristic item such as “travel distance”, which is typically considered better with a lower feature value, is being set as an axis item for either or both of the axes, products with low feature values are highlighted. Moreover, in the case where product characteristic items that can be determined to be good or bad on the basis of their feature values are being set as axis items for both of the vertical and horizontal axes, products that are considered good in terms of the feature values on both axes are highlighted more than products that are considered good in terms of the feature values only on one axis.

On the other hand, in the case where product characteristic items such as “color” or “manufacturer”, which cannot be determined to be good or bad on the basis of their feature values are being set as axis items for both of the vertical and horizontal axes, the “recommend function” does not highlight product images.

The axis item data storage portion 4B has information stored therein for each product characteristic item as to whether or not the “recommend function” can be effected on the product characteristic item (i.e., whether or not the product image can be highlighted), and further, for the product characteristic items for which highlighting is possible, information about a feature value-related condition for highlighting is stored. The condition for highlighting is set, for example, such that “the feature value for the exterior condition (on the scale with the maximum feature value at 10 and the minimum at 1) is 8 or higher”.

In the case where the “recommend function” has been executed, in step S10 or S12 of FIG. 3, the distribution diagram generating portion 6 generates data for a distribution diagram in which product images for products that satisfy the condition for highlighting are highlighted, with reference to the axis item data storage portion 4B.

As a result, the user terminal 3 displays the distribution diagram in which the product images for the products that satisfy the condition are highlighted. For example, in the case where the axis item “exterior condition” is being set for one of the axes, the product image for any product whose feature value for “exterior condition” is 8 or higher is highlighted.

Note that the product images can be highlighted in a direct manner in which the product images are changed in color or caused to blink, or in an indirect manner in which any area that satisfies the condition for highlighting is changed in color or shaded in gradations, thereby adding a visual distinction between areas that satisfy and do not satisfy the condition for highlighting.

### 10. Instant Search Function

Next, an “instant search function” will be described.

The “instant search function” is a function for generating data for an instant-search setting window (i.e., the “search condition input screen” of the present invention) in which to input search conditions to narrow down products on the basis of a plurality of product characteristic items. The data for the instant-search setting window is generated by a condition input screen generating portion (not shown) in the server 2.

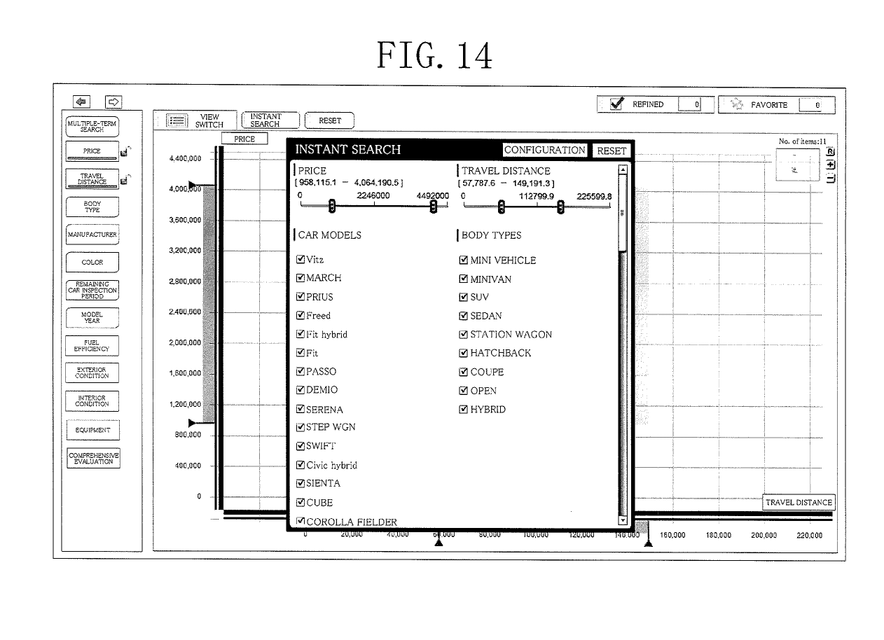

FIG. 14 is a screen on the user terminal 3 presenting the instant-search setting window. The instant-search setting window allows the user to input search conditions for narrowing down products by selecting the range of feature values for product characteristic items being set as axis items and by selecting feature values for product characteristic items other than the axis items.

The search conditions inputted via the instant-search setting window serve as refinement conditions, so that in steps S5 to S8 of FIG. 3, the distribution diagram generating portion 6 makes a verification as to whether products satisfy the inputted search conditions, and the product extracting portion 7 extracts and stores IDs of the products that satisfy the search conditions in the product ID storage portion 4C. Thereafter, the distribution diagram generating portion 6 generates data for a distribution diagram in which product images only for products corresponding to the IDs stored in the product ID storage portion 4C are arranged. As a result, the user terminal 3 displays the distribution diagram in which only the product images for the products that satisfy the search conditions inputted via the instant-search setting window are arranged.

### 11. Filter Function

Next, a “filter function” will be described.

The “filter function” is a function for, in the case where the product data stored in the product data storage portion 4A includes product characteristic items for which feature values are represented by one of two values, displaying a distribution diagram in which the product image for any product whose feature value takes one of the two values and the product image for any product whose feature value takes the other value are distinguished from each other.

The product characteristic items for which feature values are represented by one of two values include, for example, “non-smoking”, “one-owner car”, and “not new but unused car”. The feature values for such product characteristic items are represented by either one of two values, “Yes” or “No”.

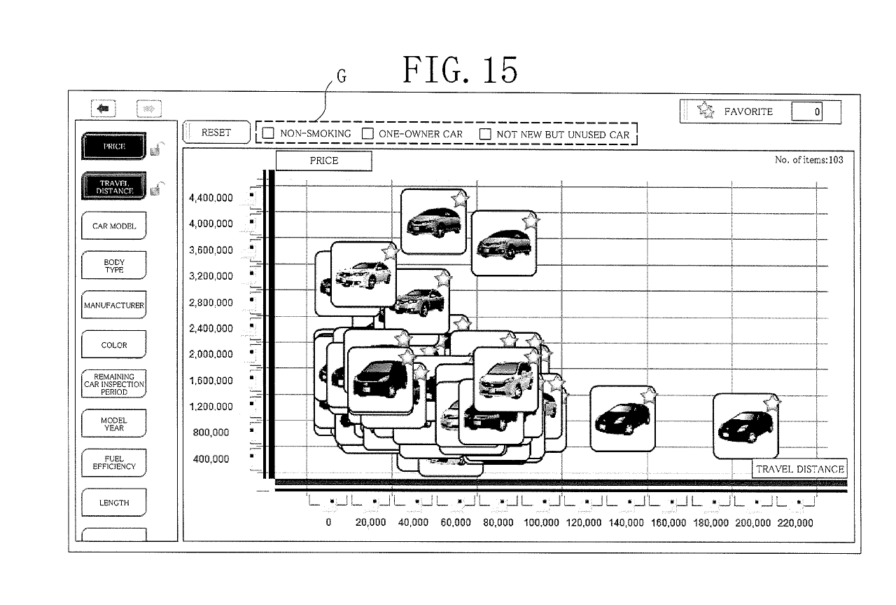

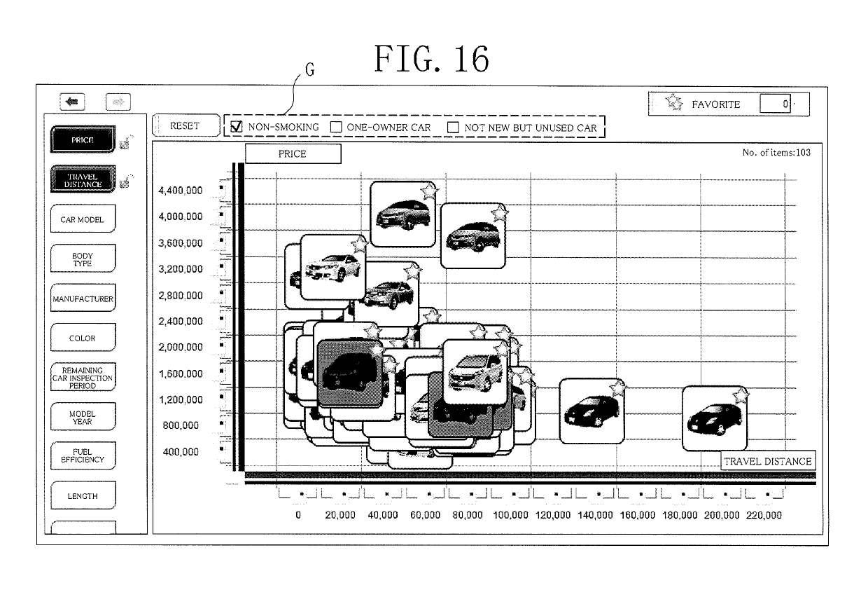

FIG. 15 is an exemplary screen on the user terminal 3, presenting a filter condition selection field in area G at the upper left of the distribution diagram. FIG. 16 is a screen displayed on the user terminal 3 after the filter condition has been selected in the filter condition selection field shown in FIG. 15.

As shown in the figures, the product characteristic items “non-smoking”, “one-owner car”, and “not new but unused car”, the feature values for which are represented by one of the two values, are displayed in the filter condition selection field in area G, and a selectable checkbox is positioned to the left of each of the displayed items. The checkbox is intended to select a filter condition, more specifically, one of the two values (e.g., “Yes”) with respect to the feature value for the product characteristic item. More specifically, in the case where the “non-smoking” checkbox is being selected, as shown in FIG. 16, the filter condition is “being non-smoking”. Furthermore, in the case where a plurality of checkboxes are being selected, the filter condition is the logical product of the selected checkboxes. More specifically, in the case where both the “non-smoking” checkbox and the “one-owner car” checkbox are being selected, the filter condition is “being a non-smoking, one-owner car”. Note that data for the filter condition selection field is generated by an unillustrated filter condition generating portion provided in the server 2. In addition, among the product characteristic items for which feature values are represented by one of the two values, which product characteristic item is to be arranged in the filter condition selection field can be set and changed arbitrarily on the server 2.

Changing filter conditions through selection or deselection causes the distribution diagram generating portion 6 to start the process shown in FIG. 3, and in step S10 (S12), data for a distribution diagram in which product images for products that do not satisfy a selected filter condition are arranged so as to be identifiable as such is generated after confirming the filter condition and also acquiring any feature value corresponding to the filter condition for each product to be displayed in the distribution diagram (i.e., for each product whose coordinate position has been derived) while referring to the product data storage portion 4A.

As a result, the user terminal 3 displays product images for both the products that satisfy the filter condition and the products that do not satisfy the filter condition, such that the former are presented in normal mode, and the latter are displayed so as to be identifiable as such. In FIG. 16, the product images for the products that do not satisfy the filter condition (i.e., not smoke-free) are displayed in gray. Accordingly, the user can instantly discern between the products that satisfy the filter condition and the products that do not satisfy the filter condition, and therefore, the user can select a desired product promptly.

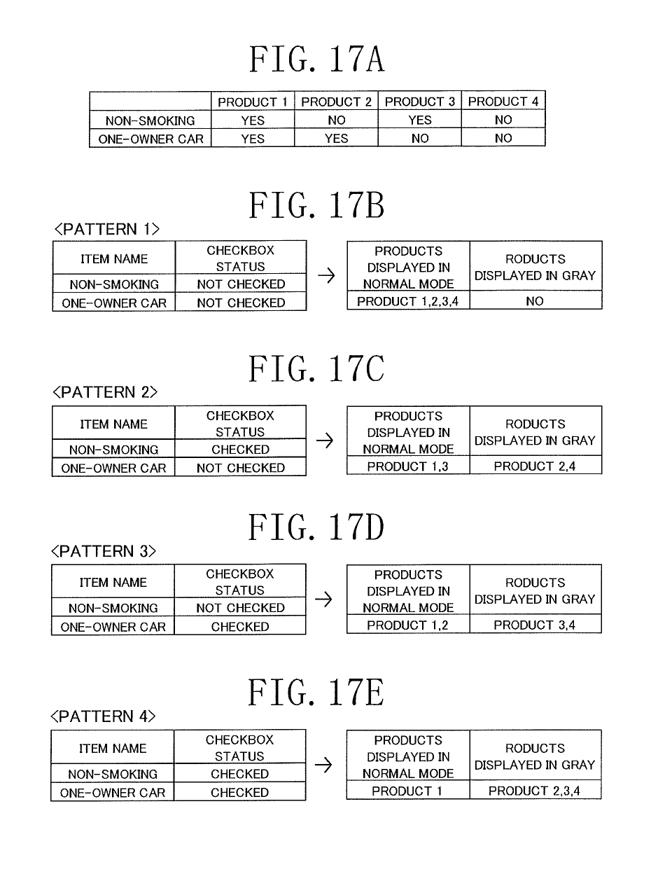

Next, the action of the “filter function” will be described specifically. In the following descriptions, only products 1 to 4 shown in FIG. 17A are assumed to be arranged in a distribution diagram for the sake of simplification. As shown in the figure, the feature values for the products with respect to “non-smoking” and “one-owner car” are Yes/Yes for product 1, “No”/“Yes” for product 2, “Yes”/“No” for product 3, and “No”/“No” for product 4.

### Pattern 1

Pattern 1 will be described where neither of the checkboxes for “non-smoking” and “one-owner car” is being selected in the filter condition selection field (see FIG. 17B).

In this case, there is no filter condition, and therefore, all of the product images for products 1 to 4 are displayed in normal mode.

### Pattern 2

Pattern 2 will be described where the checkbox for “non-smoking” is being selected in the filter condition selection field but the checkbox for “one-owner car” is not being selected (see FIG. 17C).

In this case, the filter condition is “being non-smoking”, and therefore, in step S10 (S12), the distribution diagram generating portion 6 generates data for a distribution diagram in which the product images for products 2 and 4, which do not satisfy the filter condition (i.e., not smoke-free), are arranged and displayed in gray. As a result, the user terminal 3 displays the distribution diagram in which products 1 and 3 are presented in normal mode, and products 2 and 4 are presented in gray.

### Pattern 3

Pattern 3 will be described where the checkbox for “one-owner car” is being selected in the filter condition selection field but the checkbox for “non-smoking” is not being selected (see FIG. 17D).

In this case, the filter condition is “being a one-owner car”, and therefore, in step S10 (S12), the distribution diagram generating portion 6 generates data for a distribution diagram in which the product images for products 3 and 4, which do not satisfy the filter condition (i.e., not one-owner cars) are displayed in gray. As a result, the user terminal 3 displays the distribution diagram in which products 1 and 2 are presented in normal mode, and products 3 and 4 are presented in gray.

### Pattern 4

The case where both of the checkboxes for “non-smoking” and “one-owner car” are being selected in the filter condition selection field will be described (see FIG. 17E).

In this case, the filter condition is “being a non-smoking, one-owner car”, and therefore, in step S10 (S12), the distribution diagram generating portion 6 generates data for a distribution diagram in which the product images for products 2, 3, and 4, which do not satisfy the filter condition (i.e., not smoke-free, not a one-owner car, or neither of them), are arranged and displayed in gray. As a result, the user terminal 3 displays the distribution diagram in which product 1 is presented in normal mode, and products 2, 3, and 4 are presented in gray.

Note that the distribution diagram generating portion 6 has been described above as generating data in step S10 (S12) for a distribution diagram in which the product images for the products that do not satisfy the filter condition are arranged so as to be identifiable as such, but instead of this, the distribution diagram generating portion 6 may generate data for a distribution diagram in which the product images for the products that satisfy the filter condition are arranged so as to be identifiable as such. For example, in the case of Pattern 4, when the product images for the products that satisfy the filter condition are arranged so as to be identifiable as such, the user terminal 3 displays a distribution diagram in which products 2, 3, and 4 are presented in normal mode, and product 1 is presented in gray. Furthermore, in the above descriptions, the display in gray is used for identification, but any form of display can be used so long as it is distinguishable from normal display.

### 12. Other Functions

In addition to the above functions, the product search system 1 has the function of displaying a “back” button for undoing the last action and a “forward” button for reversing the last undone action, in order to go back and forward in history.

While the preferred embodiment of the product search system according to the present invention has been described above, the present invention is not limited to the features thereof.

For example, in the case where arbitrary sections of the vertical and horizontal axes are selected on the user terminal 3, the distribution diagram generating portion 6 in the above embodiment generates data for a distribution diagram in which only the product images inside an area consisting of the selected sections or inside an overlapping area of two or more such arbitrary sections are arranged, but instead of such data, data for a distribution diagram in which the product images outside such an area are displayed in lighter colors than the product images inside that area may be generated. In the case where the product images outside the area are displayed in lighter colors than the product images inside the area, for example, in step S9 of FIG. 3, the distribution diagram generating portion 6 derives the coordinate positions of all of the products corresponding to the IDs acquired in step S2, and then in step S10, the distribution diagram generating portion 6 generates data for a distribution diagram in which the product images outside the area are displayed in lighter colors than the product images inside the area (i.e., the product images for the products corresponding to the IDs stored in the product ID storage portion 4C in step S7). As a result, the product images inside the area are relatively more highlighted, so that the user can narrow down the products both intuitively and visually.

Furthermore, in the above embodiment, each section can be selected by clicking a numerical value or character string that represents a feature value for the section or the button b provided near the numerical value or character string, using the mouse pointer or suchlike, but instead of this, each section may be selected using a slider provided on each of the vertical and horizontal axes and having knobs on opposite ends so that positional adjustments along the vertical and horizontal axes can be made in steps corresponding to the number of preset axis divisions.

Furthermore, in the product search system 1 according to the above embodiment, the server 2 executes the process for causing the user terminal 3 to display a distribution diagram, but the process for displaying a distribution diagram may be executed on the user terminal 3. For example, the user downloads a file, such as an “SWF file”, which allows execution of the process for displaying a distribution diagram, through a browser on the user terminal 3, so that the storage portion 4, the two-dimensional coordinate space defining portion 5, the distribution diagram generating portion 6, the product extracting portion 7, the display mode switching portion 8, the list generating portion 9, and so on (note that the data communication portion 10 is not included) can be constructed on the user terminal 3, as on the server 2. Accordingly, the user can display a distribution diagram on the user terminal 3 using any of the functions specified in 1 to 12 above, without using the server 2. In such a case, one user terminal 3 can serve as a product search system.

### DESCRIPTION OF THE REFERENCE CHARACTERS

1 product search system

2 server

3 user terminal

4 storage portion

4A product data storage portion

4B axis item data storage portion

4C product ID storage portion

4D specified product ID storage portion

4E in-frame product ID storage portion

5 two-dimensional coordinate space defining portion

6 distribution diagram generating portion

7 product extracting portion

8 display mode switching portion

9 list generating portion

10 data communication portion

1-14. (canceled)

15. A product search system allowing a user to search for a desired product by displaying a distribution diagram on a user terminal with product images for a plurality of products arranged in a two-dimensional coordinate space, the system comprising:
a product data storage portion having product data stored for each product, the product data including unique identification information of the product, an image for the product, and feature values for the product with respect to a plurality of product characteristic items;
an axis item data storage portion having settability information and an axis division number stored for each product characteristic item, the settability information indicating whether or not the product characteristic item is settable as an axis item for either a vertical or horizontal axis of the two-dimensional coordinate space, the axis division number being set for dividing the vertical or horizontal axis into a plurality of sections;
a product ID storage portion and a specified product ID storage portion for storing unique identification information of products arranged in the distribution diagram;
a display mode switching portion for switching a display mode between a normal display mode in which to display product images for products whose data is stored in the product data storage portion and a specified product display mode in which to display product images only for products corresponding to unique identification information stored in the specified product ID storage portion;
a two-dimensional coordinate space defining portion for setting product characteristic items selected by the user as axis items for the vertical and horizontal axes, setting ranges of the vertical and horizontal axes on the basis of the product characteristic items for all products whose data is stored in the product data storage portion when the display mode is the normal display mode, or on the basis of the product characteristic items for the products corresponding to the unique identification information stored in the specified product ID storage portion when the display mode is the specified product display mode, and defining the two-dimensional coordinate space with each of the vertical and horizontal axes divided into the sections on the basis of the axis division numbers for the product characteristic items;
a distribution diagram generating portion for confirming the display mode, acquiring the unique identification information of all products whose data is stored in the product data storage portion when the display mode is the normal display mode, or the unique identification information stored in the specified product ID storage portion when the display mode is the specified product display mode, deriving coordinate positions of the products whose unique identification information has been acquired in the two-dimensional coordinate space on the basis of the feature values for the product characteristic items being set as the axis items, and generating data for a distribution diagram in which product images for the products whose unique identification information has been acquired are arranged in the coordinate positions; and
a product extracting portion for extracting and storing unique identification information in the product ID storage portion and the specified product ID storage portion, the unique identification information stored in the product ID storage portion being unique to products included in an area of an arbitrary section selected from among the sections, or an overlapping area of two or more such arbitrary sections, on the user terminal displaying the distribution diagram by the user clicking a numerical value or character string that represents a feature value for the section with respect to a product characteristic item, or by the user clicking a button provided along with the numerical value or character string, the unique identification information stored in the specified product ID storage portion being unique to products corresponding to product images specified by the user from among all of the product images on the user terminal displaying the distribution diagram, wherein,
once the user selects the arbitrary section and the unique identification information is stored in the product ID storage portion, the distribution diagram generating portion generates data for a post-refinement distribution diagram in which product images for the products corresponding to the unique identification information acquired in accordance with the display mode and stored in the product ID storage portion are relatively highlighted, and
when the display mode is the normal display mode, once an arbitrary product image in the post-refinement distribution diagram is specified by the user, and unique identification information of a product corresponding to the product image is stored in the specified product ID storage portion, the distribution diagram generating portion corrects the data for the distribution diagram such that the product image for the product corresponding to the unique identification information stored in the specified product ID storage portion is visually distinguishable from other product images.

16. The product search system according to claim 15, wherein the distribution diagram generating portion generates data for a post-refinement distribution diagram in which product images only for the products corresponding to the unique identification information stored in the product ID storage portion are arranged in the two-dimensional coordinate space, whereby the product images are relatively highlighted.

17. The product search system according to claim 15, wherein,
once a new axis item is selected in the post-refinement distribution diagram, the two-dimensional coordinate space defining portion defines a two-dimensional coordinate space in which the ranges of the vertical and horizontal axes are set on the basis of the product characteristic items being set as the axis items for all products whose data is stored in the product data storage portion when the display mode is the normal display mode, or for the products corresponding to the unique identification information stored in the specified product ID storage portion when the display mode is the specified product display mode, and
the distribution diagram generating portion generates data for a distribution diagram in which only the product images for the products corresponding to the unique identification information stored in the product ID storage portion are arranged in the two-dimensional coordinate space.

18. The product search system according to claim 15, wherein, when products whose feature values for the product characteristic items being set as the axis items fall within a given preset range are arranged in the two-dimensional coordinate space, the distribution diagram generating portion generates data for a distribution diagram in which product images for the products are highlighted.

19. The product search system according to claim 15, wherein, when the number of product images arranged in the two-dimensional coordinate space is greater than or equal to a predetermined number, the distribution diagram generating portion generates data for a distribution diagram in which symbol marks are arranged as the product images.

20. The product search system according to claim 15, wherein the distribution diagram includes a product selection frame provided for displaying a portion of the diagram at and around an arbitrary coordinate position specified by the user in an enlarged view, thereby allowing selection of a predetermined number of product images around the coordinate position,
once the predetermined number of product images are selected by the product selection frame, the product extracting portion extracts unique identification information of products corresponding to the predetermined number of product images, and stores the unique identification information in the in-frame product ID storage portion,
the two-dimensional coordinate space defining portion defines a two-dimensional coordinate space in which ranges of the vertical and horizontal axes are set on the basis of the product characteristic items being set as the axis items for all products corresponding to the unique identification information stored in the in-frame product ID storage portion, and
the distribution diagram generating portion generates data for a distribution diagram in which product images only for the products corresponding to the unique identification information stored in the in-frame ID storage portion are arranged.

21. The product search system according to claim 15, wherein the two-dimensional coordinate space defining portion defines a two-dimensional coordinate space in which the ranges of the vertical and horizontal axes are set on the basis of a calculation result obtained by adding values resulting from a weighting calculation being performed on the basis of a predetermined order of priority after setting two or more product characteristic items as axis items for either the vertical or horizontal axis or both and normalizing possible feature values for the product characteristic items.

22. The product search system according to claim 15, further comprising a condition input screen generating portion for generating data for a search condition input screen in which to input a search condition for narrowing down products on the basis of a plurality of product characteristic items, wherein,
the product extracting portion extracts unique identification information of products that satisfy the search condition, and stores the unique identification information in the product ID storage portion.

23. The product search system according to claim 15, further comprising a list generating portion for generating data for a list of product data for products corresponding to arbitrary product images in the distribution diagram.

24. The product search system according to claim 23, wherein, when the number of product images arranged in the post-refinement distribution diagram is less than or equal to a predetermined number, the list generating portion automatically generates data for a list of product data for products corresponding to all product images in the post-refinement distribution diagram.

25. The product search system according to claim 15, wherein,
the product data stored in the product data storage portion includes product characteristic items for which feature values are represented by one of two values,
the system further includes a filter condition generating portion for generating data for a filter condition selection field in which to select one of the two values as the filter condition for each product characteristic item, and
once the value for the product characteristic item is selected in the filter condition selection field, the distribution diagram generating portion generates data for a distribution diagram in which product images for products whose feature values take the other value are arranged and displayed in a different color so as to be visually distinguishable from other product images in the distribution diagram, as not satisfying the filter condition.

26. The product search system according to claim 15, wherein,
the product data stored in the product data storage portion includes product characteristic items for which feature values are represented by one of two values,
the system further includes a filter condition generating portion for generating data for a filter condition selection field in which to select one of the two values as the filter condition for each product characteristic item, and
once the value for the product characteristic item is selected in the filter condition selection field, the distribution diagram generating portion generates data for a distribution diagram in which product images for products whose feature values take the selected value are arranged and displayed in a different color so as to be visually distinguishable from other product images in the distribution diagram, as satisfying the filter condition.
